(19) United States
(12) Patent Application Publication
(10) Pub. No.: US 2025/0128627 A1
(43) Pub. Date: Apr. 24, 2025

(54) SOLAR CHARGED AUXILIARY POWER UNIT WITH UNIVERSAL ACCESSORY MOUNT FOR PERSONAL WATERCRAFT

(71) Applicant: West Dynamics LLC, Cincinnati, OH (US)

(72) Inventor: William Tyler West, Cincinnati, OH (US)

(21) Appl. No.: 18/920,233

(22) Filed: Oct. 18, 2024

Related U.S. Application Data
(60) Provisional application No. 63/544,684, filed on Oct. 18, 2023.

(51) Int. Cl. B60L 53/51; B60L 53/30; B60L 53/62

(52) U.S. Cl. CPC B60L 53/51; B60L 53/305; B60L 53/62; B60L 2200/32; B60L 2210/10

(57) ABSTRACT

The present disclosure teaches an advanced auxiliary power system designed for personal watercraft. The system includes an energy storage system, a power management system, a comprehensive wiring harness, a watertight mounting system, a universal accessory mount, and a multimodal user interface. The energy storage system includes one or more rechargeable batteries and a battery management system. The power management system includes an advanced charge controller, one or more solar panels, a DC-DC converter, and a power distribution system. The universal accessory mount includes one or more adjustable mounting points wherein the universal accessory mount is configured to attach to the watertight mounting system.

### CROSS-REFERENCE TO RELATED APPLICATIONS

This application claims priority to U.S. Provisional Patent Application No. 63/544,684, filed Oct. 18, 2023, the entirety of which is incorporated by reference herein for all purposes.

### TECHNICAL FIELD

Disclosed embodiments relate to the field of marine electrical power generation and control. More specifically, the disclosed embodiments relate to an efficient power system that integrates renewable energy sources, an energy storage system, a power distribution system, and a user interface.

### BACKGROUND

The field of personal watercraft has experienced significant growth over the past decade, with manufacturers offering a greater variety of models than ever before. One notable segment within this category is fishing kayaks, which have surged in popularity among outdoor enthusiasts. Fishing kayaks now account for a substantial portion of personal watercraft sales, as they offer affordability, portability, and access to waters that are difficult to reach with larger vessels. The versatility and cost-effectiveness of fishing kayaks have made them an attractive option for both novice and experienced anglers.

As the popularity of fishing kayaks and other personal watercraft has grown, so has the desire among enthusiasts to customize and equip their vessels with advanced technologies and accessories. Users seek to enhance their on-water experience by adding devices such as fish finders, GPS navigation systems, lighting, communication equipment, and other electronic accessories. However, integrating these systems presents several challenges. Most innovations in electronics, systems control, and environmental protection have been focused on the powerboat industry, leaving personal watercraft users without tailored solutions.

In the late 2010s, kayak manufacturers began incorporating pedal-driven propulsion systems and other high-end accessories into their product lines, recognizing the demand for enhanced performance and functionality. This endeavor proved successful and led to the inclusion of battery-powered integrated trolling motor systems, providing users with additional propulsion options. Prior to these developments, kayak enthusiasts typically relied on small auxiliary batteries to power basic onboard electronics, often requiring custom installations and do-it-yourself solutions.

Despite the ongoing electrification of personal watercraft, the responsibility for designing, installing, and maintaining a unique power delivery system still largely rests with the end user. This process can be complex and time-consuming, particularly for those without technical expertise. Users must often source individual components—such as batteries, wiring harnesses, switches, and protective enclosures—and assemble them into a functional system. Additionally, these ad-hoc setups may lack proper protection against the harsh marine environment, leading to issues with corrosion, water ingress, and overall reliability. The increasing popularity of personal watercraft has also led to greater congestion on recreational waters, where they compete for space with larger powerboats. However, there are currently no specific regulations addressing safety, identification, or navigation lighting for personal watercraft. This lack of standardized lighting and signaling equipment poses safety risks, especially in low-light conditions or adverse weather, as personal watercraft may be less visible to other vessels. The absence of regulations also means that users are left to interpret and implement safety measures on their own, often resulting in inconsistent and inadequate solutions.

Therefore, there is a clear need for a streamlined, user-friendly solution that consolidates and enhances the emerging electronic systems available for personal watercraft. Such a solution should do one or more of the following. Simplify installation and maintenance of auxiliary power systems, reducing the technical burden on the user. Provide advanced control and monitoring capabilities, including multimodal interfaces like a voice recognition interface, a mobile application interface, and/or remote controls. Offer robust protection against environmental factors such as water exposure, corrosion, and temperature extremes. Enhance safety by incorporating standardized navigation and safety lighting systems compliant with maritime regulations. Facilitate compatibility with a wide range of 12V DC marine accessories and future technological advancements. By offering a comprehensive auxiliary power unit that integrates energy storage, power management, control interfaces, and environmental protection, users can significantly improve their personal watercraft experience. This solution addresses both the technical challenges and safety concerns currently faced by enthusiasts, providing a reliable and efficient system that enhances functionality while promoting safer navigation on congested waterways.

This disclosure aims to address the need for a streamlined solution that consolidates and enhances many of the emerging electronic systems available in the current market.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a front view of the auxiliary power unit of the present disclosure;

FIG. 2 is a rear view of the auxiliary power unit of FIG. 1;

FIG. 3 is a partial assembly of the onboard running light assembly of an embodiment of the auxiliary power unit of the present disclosure;

FIG. 4 is a partial assembly of the front interface panel assembly of an embodiment of the auxiliary power unit of the present disclosure;

FIG. 5 is a partial assembly of the rear interface panel assembly of an embodiment of the auxiliary power unit of the present disclosure;

FIG. 6 is a partial assembly of the primary printed circuit board assembly of an embodiment of the auxiliary power unit of the present disclosure;

FIG. 7 is a partial assembly of the energy storage system of an embodiment of the auxiliary power unit of the present disclosure;

FIG. 8A is a bottom view of a partial assembly of the universal accessory mount of an embodiment of the auxiliary power unit of the present disclosure;

FIG. 8B is a side view of a partial assembly of the universal accessory mount of an embodiment of the auxiliary power unit of the present disclosure;

FIG. 9 is a partial assembly of the wiring harness assembly of an embodiment of the auxiliary power unit of the present disclosure;

FIG. 10 shows the auxiliary power unit secured to a kayak;

FIG. 11 shows the auxiliary power unit and accessories in bulkhead mount configuration;

FIG. 12 is a side view of the auxiliary power unit and accessories in bulkhead mount configuration;

FIG. 13 shows the auxiliary power unit secured to a canoe;

FIG. 14 shows the auxiliary power unit and accessories in clamp mount configuration;

FIG. 15 is a side view of the auxiliary power unit and accessories in clamp mount configuration;

FIG. 16 shows the auxiliary power unit secured to a kayak;

FIG. 17 shows the auxiliary power unit and accessories in track mount configuration;

FIG. 18 is a side view of the auxiliary power unit and accessories in track mount configuration;

FIG. 19 shows the auxiliary power unit secured to a power boat; and

FIG. 20 shows the auxiliary power unit and accessories in tube mount configuration.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

There is a need for a streamlined solution that not only simplifies the installation of auxiliary power systems for personal watercraft but also enhances user interaction, safety, and system intelligence. Existing solutions often lack modern corrosion and element protection, require complex maintenance, and do not cater to the evolving technological needs of users. The ideal solution should be accessible to a wider range of users and offer advanced control and monitoring capabilities.

In one or more embodiments, the present disclosure provides a versatile and user-friendly auxiliary power system for personal watercraft that addresses these needs. In one or more embodiments, systems of the present disclosure may feature: 1) Multimodal Control Interfaces: Users can control the APU via voice recognition, a mobile application, a Bluetooth® Low Energy (BLE) remote, and/or a wired remote, allowing for hands-free operation and enhanced convenience. 2) Plug-and-Play Functionality: A removable auxiliary power unit and wiring harness may enable straightforward installation and simple transferability between watercraft, reducing setup time and complexity. 3) Advanced Sensor Suite: Integrated sensors, including an inertial measurement unit (IMU), proximity sensor, color and light sensor, humidity and temperature sensors, and pressure sensor, monitor environmental and operational parameters, enhancing safety and performance. 4) Mesh Networking and Sensor Fusion: The system may communicate with BLE-capable accessories that may have their own onboard sensors, creating a mesh network. This may allow for sensor fusion capabilities, improving data accuracy and system responsiveness. 5) Enhanced Power Distribution System: Utilizing economical resettable fuses and GPIO-controlled MOSFETs, the power distribution system may provide reliable circuit protection and switching capabilities, tailored specifically for this application. 6) Safety and Navigation Lighting: Features onboard running lights, cockpit lights, and masthead lighting that may comply with maritime regulations, improving visibility and safety. 7) Centralized and Accessible Accessory Mounting Solution: A universal accessory mount may provide a secure and adjustable platform for attaching a wide range of devices and accessories, enhancing the system's versatility. 8) Durable Protection Against Elements and Corrosion: Constructed with materials and design considerations that offer robust protection against harsh marine environments, extending the system's lifespan and reducing maintenance requirements. 9) Renewable Energy Charging Capability: May support renewable energy sources such as solar panels and wind turbines to recharge the energy storage system, extending time on the water and reducing reliance on external power sources. 10) Compatibility with Common 12V DC Marine Accessories: May ensure seamless integration with a wide range of marine devices, allowing users to customize their watercraft according to their specific needs.

This comprehensive solution not only simplifies the installation and maintenance of auxiliary power systems for personal watercraft but also introduces advanced features that enhance user experience, safety, and system functionality. By integrating modern control methods and sensor technologies, the system may be accessible to a wider range of users and may meet the evolving demands of personal watercraft enthusiasts.

In one or more embodiments, the present disclosure may provide a versatile and advanced auxiliary power unit (APU) designed for attachment to personal watercraft such as canoes, kayaks, sailboats, stand-up paddleboards, or small boats without on-board power. The unit may be equipped with renewable energy charging capabilities, including solar panels (such as solar panels 22) and support for wind turbines and other renewable energy sources, allowing it to supply electrical energy without relying solely on traditional fuel sources or external electrical supply.

In one or more embodiments, the APU may be engineered to power a variety of on-board systems and devices, including lighting, communication equipment, navigation systems, sensors, and appliances. APU may feature an advanced power management system that utilizes economical resettable fuses and GPIO-controlled MOSFETs for reliable circuit protection and switching capabilities, tailored specifically for this application. The APU may replace the need for external eFuse modules, enhancing safety and reducing reliance on discrete units not purpose-designed for the system. The APU may incorporate a comprehensive sensor suite, including an inertial measurement unit (IMU), proximity sensor, color and light sensor, humidity and temperature sensors, and pressure sensor. These sensors monitor environmental and operational parameters, enhancing safety, performance, and providing users with detailed telemetry data.

The APU may offer multimodal control interfaces, enabling users to interact with the system via voice recognition commands, a mobile application through Bluetooth® Low Energy (BLE) communication, a BLE remote, and/or a wired remote control. This flexibility enhances user convenience and safety, allowing for hands-free operation and remote management of the unit's functions. Users can control various circuits, access telemetry information, and adjust settings through these interfaces. Designed with compatibility in mind, the APU may support integration with a wide range of common 12V DC marine accessories and devices, as well as potential future innovations that operate on similar power requirements or interface through the unit's universal sensor connection. The APU's plug-and-play functionality, removable wiring harness, and universal accessory mount facilitate straightforward installation and simple transferability between different watercraft, making it accessible to a wider range of users. The APU's durable construction may provide robust protection against harsh marine environments, including corrosion and exposure to the elements. By incorporating renewable energy charging capabilities, advanced control methods, and a comprehensive sensor suite, the APU may extend time on the water, enhance safety, and improve the overall experience for personal watercraft enthusiasts.

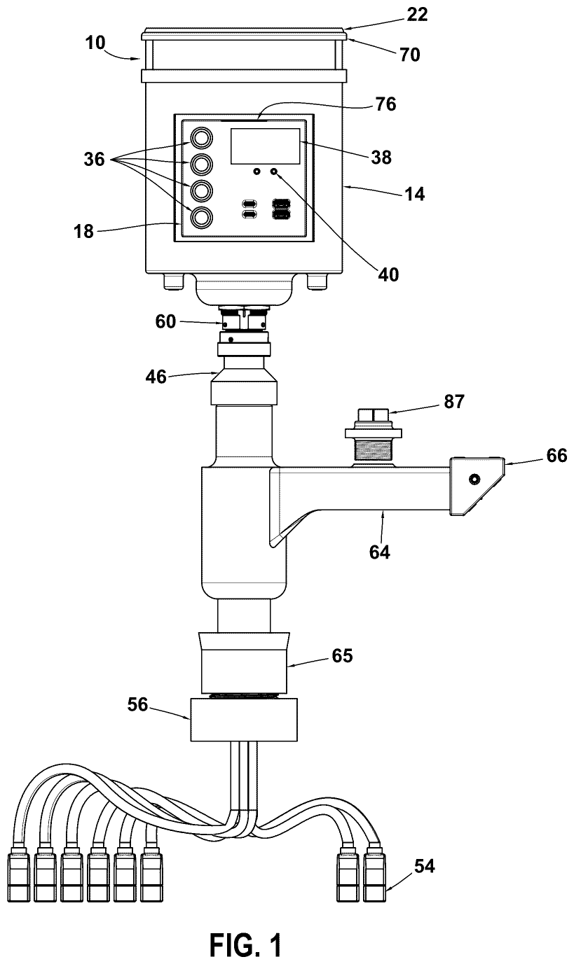

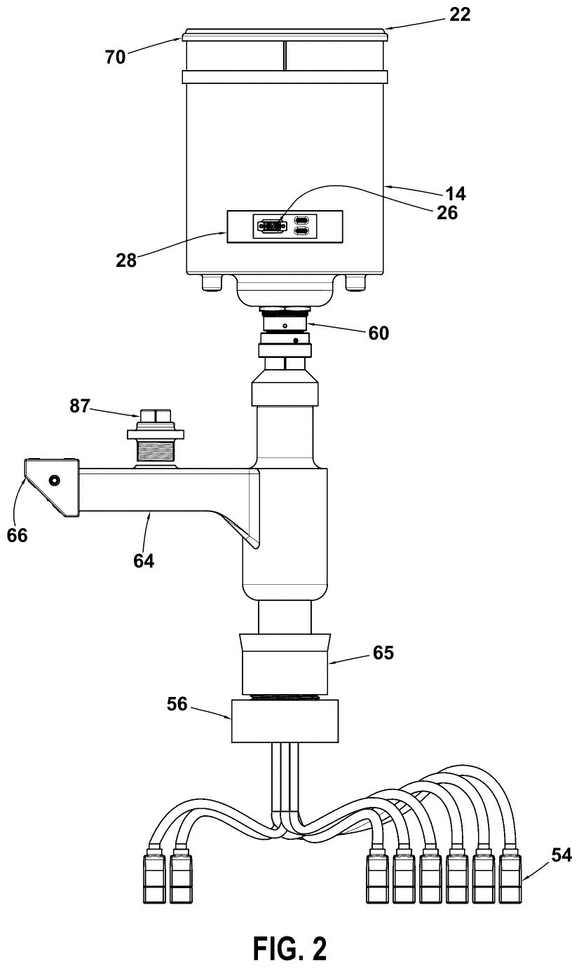

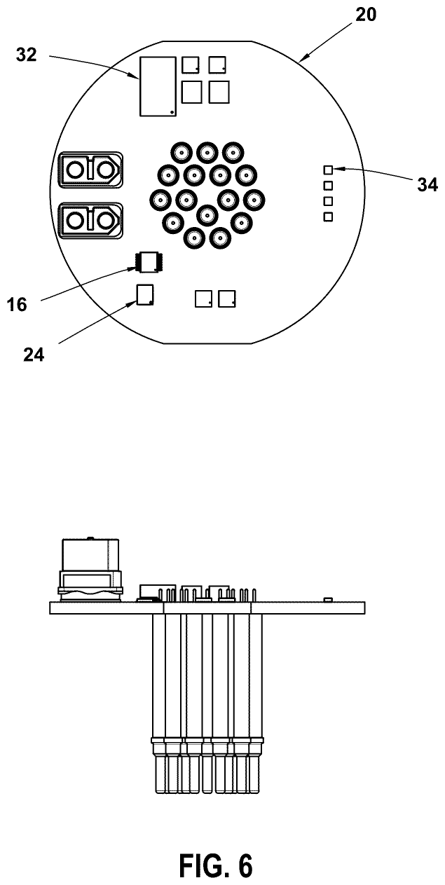

FIGS. 1 and 2 illustrate an embodiment of the auxiliary power unit (APU) 10 of the present disclosure. APU 10 contains an energy storage system 12 (not shown in FIGS. 1 and 2) housed within a durable housing unit 14 designed to protect against harsh marine environments. Energy storage system 12 stores electrical energy using rechargeable batteries 13, which may include lithium iron phosphate (LiFePO₄), lithium-ion, lead-acid, or other suitable battery chemistries. Batteries 13 enable the capture, storage, and release of energy, providing flexibility for APU 10 to operate independently without requiring connection to an external battery. Energy storage system 12 may incorporate an advanced battery management system (BMS) 16 (not shown in FIGS. 1 and 2) that monitors, controls, and protects rechargeable batteries 13. BMS 16 may ensure a safe and efficient operation by managing charging and discharging processes, balancing cell voltages, and providing protection against overvoltage, undervoltage, overcurrent, and temperature extremes. BMS 16 may be integrated into a printed circuit board assembly (PCBA) 20, as shown in FIG. 6, which may be housed within housing unit 14.

In addition to battery management functions, PCBA 20 may also host a microcontroller unit (MCU) and other electronics responsible for advanced features for APU 10. These advanced features may include a power management system utilizing economical resettable fuses and GPIO-controlled MOSFETs for reliable circuit protection and switching capabilities, as well as interfaces for an integrated sensor suite and control modules. APU 10 may integrate a comprehensive sensor suite, including an inertial measurement unit (IMU), proximity sensor, color and light sensor, humidity and temperature sensors, and pressure sensor. These sensors may provide real-time data on environmental and operational parameters, enhancing safety, performance, and user awareness.

In one or more embodiments, APU 10 may also feature multimodal control interfaces, allowing users to interact with the system via voice recognition commands, a mobile application through Bluetooth® Low Energy (BLE) communication, a BLE remote, and/or a wired remote control. This flexibility enhances user convenience and safety, enabling hands-free operation and remote management of functions of APU 10. In one or more embodiments, housing unit 14 may be designed to accommodate various components securely while providing protection against water ingress, corrosion, and mechanical impacts. Housing unit 14 may ensure that energy storage system 12, battery management system 16, PCBA 20, and associated electronics operate reliably in the challenging conditions typical of marine environments.

Some of the main features of battery management system (BMS) 16 may be to monitor the state of charge (SoC) and state of health (SoH) of rechargeable batteries 13 within the energy storage system 12. BMS 16 may employ advanced algorithms and may utilize integrated circuits to provide precise and real-time monitoring of the overall condition of batteries 13, remaining lifespan of batteries 13, and performance characteristics of batteries 13. BMS 16 may also safeguard energy storage system 12 and its individual cells from overvoltage, undervoltage, overcurrent, and temperature extremes, ensuring safe and efficient operation. Included in BMS 16 may be a high-performance integrated circuit that manages cell balancing, regulates temperature, limits current flow, and detects faults or abnormalities such as open circuits or short circuits. BMS 16 may utilize data from integrated temperature sensors and other components of the comprehensive sensor suite to optimize battery performance and longevity.

In one or more embodiment, integrated circuit of BMS 16 may also supply high-accuracy, self-discharge compensated voltage and current data, as well as aging information, for presentation on a battery management display located on an interface panel 18 of housing unit 14. This data may also be accessible not only through the physical display but also via multimodal control interfaces, including voice recognition commands, a mobile application through Bluetooth® Low Energy (BLE) communication, a BLE remote, and/or a wired remote control. Users can monitor detailed battery telemetry information, receive alerts for any abnormal conditions, and adjust settings for optimal battery management through these interfaces. Furthermore, BMS 16 may integrate with the power management system, which may utilize economical resettable fuses and GPIO-controlled MOSFETs for reliable circuit protection and switching capabilities. This design may replace the need for external eFuse modules, enhancing safety and providing precise control over power distribution to connected devices and circuits. By combining advanced monitoring, protection features, and integration with control interfaces, BMS 16 may enhance the reliability, safety, and user experience of APU 10. BMS 16 may ensure that energy storage system 12 operates optimally under various conditions, extending the lifespan of batteries 13 and providing users with comprehensive control and visibility over the system's performance.

In one or more embodiments of the present disclosure, APU 10 may be powered by one or more renewable energy sources, including solar panels 22, wind turbines, and other supplemental energy collection devices. In the embodiment shown in FIGS. 1 and 2, solar panels 22 are mounted on a top surface of housing unit 14; however, alternative placement locations for solar panels 22 are also contemplated to accommodate different watercraft configurations and optimize energy capture. Similarly, wind turbines or other energy harvesting devices can be integrated or mounted externally, providing additional sources of renewable power. When solar panels 22 are used to power APU 10, sunlight strikes the photovoltaic cells, which absorb and convert the solar energy into direct electric current. This current, along with energy generated from other sources like wind turbines or wave energy generators, may then be directed to an advanced charge controller 24 located on printed circuit board assembly 20. Charge controller 24 may regulate and optimize the flow of energy from multiple inputs into energy storage system 12 while continuously monitoring the system's status.

In one or more embodiments, charge controller 24 may be designed to handle inputs from various renewable energy sources simultaneously, employing maximum power point tracking (MPPT) algorithms to maximize energy harvest under changing environmental conditions. Charge controller 24 may take into consideration the specific battery chemistry, cell count, and voltage/current requirements of rechargeable batteries 13 within energy storage system 12. Charge controller 24 may also ensure efficient charging by adjusting parameters in real-time, optimizing performance, and extending battery life of batteries 13. In addition to energy regulation, in one or more embodiments charge controller 24 may integrate with APU's 10 advanced control interfaces, allowing users to monitor and manage the charging process through a physical user interface 18, a voice recognition interface, a mobile application interface via Bluetooth® Low Energy (BLE) communication, a BLE remote-based interface, and/or a wired remote-control interface. Users can access detailed telemetry information, such as input voltages and currents from each energy source, battery status, and system performance metrics. They can also configure charging parameters, set alerts for specific conditions, and receive notifications through these interfaces. The integration of renewable energy sources and advanced control methods enhances APU's 10 capability to operate independently without reliance on traditional fuel sources or external electrical supply. This may extend the time users can spend on the water by efficiently harnessing natural energy, contributing to a more sustainable and eco-friendly experience. APU 10 may also accommodate future advancements in renewable energy technologies, ensuring adaptability and longevity.

In one or more embodiments of the present disclosure, APU 10 supports direct DC charging. In this method, a direct current (DC) power source, such as external batteries, DC power supplies, or other compatible DC sources, may be directly connected to a main unit charging port 26 located on a rear panel 28. This flexible connection may allow users to power APU 10 using readily available DC sources, enhancing convenience and adaptability in various environments. The direct current supplied through charging port 26 may then be routed to advanced charge controller 24 situated on PCBA 20. Charge controller 24 may then condition and manage the incoming electrical power to effectively charge energy storage system 12. Charge controller 24 may also consider the specific battery chemistry, cell configuration, and voltage/current requirements of rechargeable batteries 13 within energy storage system 12.

Charge controller 24 may also regulate and optimize the flow of energy into energy storage system 12, ensuring efficient charging while preventing overcharging or damage to batteries 13. Charge controller 24 may continuously monitor the status of energy storage system 12 by utilizing data from integrated sensors, including voltage, current, temperature, and state of charge (SoC). This real-time monitoring may allow charge controller 24 to adjust charging parameters dynamically, optimizing performance and extending battery life. In addition to managing the charging process, charge controller 24 may integrate with the advanced control interfaces of APU 10. Users can monitor the charging status, view detailed telemetry data, and adjust charging settings through multiple methods. Some of those methods may include physical user interface 18 which may provide direct interaction via buttons and display; a voice recognition interface which may allow for hands-free control by issuing spoken instructions; a mobile application interface via Bluetooth® Low Energy (BLE) Communication which may offer remote monitoring and control through a user-friendly app; and/or a BLE remote or wired remote control interface which may enable control from a distance using dedicated remote devices. This multimodal interaction may enhance user experience by offering flexibility and convenience in managing the charging process.

In one or more embodiments of the present disclosure, APU 10 may be powered by an alternating current (AC) power source, such as a standard electrical outlet connected through an AC to DC converter or charger. The AC to DC converter may be plugged into main unit charging port 26 on rear panel 28. The converter may then transform the AC power into DC power compatible with the unit's charging requirements. The converted DC current may then be directed to advanced charge controller 24 on PCBA 20. Similar to direct DC charging, charge controller 24 may regulate and optimize the flow of energy into energy storage system 12 while continuously monitoring the system's status. Charge controller 24 may then ensure efficient and safe charging by adjusting parameters based on real-time data and the specific characteristics of rechargeable batteries 13. Users can manage and monitor the AC charging process through the advanced control interfaces of APU 10, including physical user interface 18, voice recognition commands, mobile application via BLE, BLE remote, and/or wired remote control. This may provide flexibility and convenience, allowing users to charge APU 10 from standard electrical outlets when available, such as at home, marinas, or docking stations.

In one or more embodiments of the present disclosure, a wind turbine is utilized as an additional renewable energy source to power APU The wind turbine can be mounted to the top surface of the personal watercraft or any suitable location that captures wind effectively. The turbine may the harness wind kinetic energy to drive a permanent magnet DC generator, producing direct current. The generated DC current from the wind turbine may then be routed to advanced charge controller 24 on PCBA 20. Charge controller 24 may then manage and optimize the incoming energy, integrating it with other power inputs such as solar panels 22 or direct DC sources. Charge controller 24 may then employ maximum power point tracking (MPPT) algorithms and real-time data to maximize energy harvest under varying wind conditions. As with other charging methods, users can monitor and control the wind turbine charging process through the advanced control interfaces of APU 10. Charge controlle4 24 may then provide telemetry data on wind energy input, charging status, and battery conditions, accessible via physical user interface 18, voice recognition commands, mobile application via BLE, BLE remote, and/or wired remote control.

APU 10 may utilize an advanced power management system to efficiently regulate and distribute electrical energy from energy storage system 12 to various onboard systems and devices. The power management system may include several integrated components working together to optimize energy usage, ensure reliable power supply, and enhance safety. At the core of the power management system may be charge controller 24, which may monitor and regulate the charging process of energy storage system 12 based on the specific battery chemistry and configuration of rechargeable batteries 13. Charge controller 24 may employ sophisticated algorithms, including maximum power point tracking (MPPT) and adaptive charging profiles, to optimize charging parameters such as voltage and current. This may ensure that energy storage system 12 receives the maximum amount of power from renewable energy sources like solar panels 22, wind turbines, or other inputs. Charge controller 24 may also integrate with the comprehensive sensor suite and advanced control interfaces, providing users with real-time telemetry data, configurable settings, and alerts for optimal charging and battery management. Users can access this information and control charging processes via physical user interface 18, voice recognition commands, mobile application via BLE, BLE remote, and/or wired remote control. Charge controller 24 may provide APU 10 with several safety features, including: short-circuit and overload protection by preventing damage due to excessive current or faults in connected devices; overtemperature warning and protection by monitoring temperature using integrated sensors and adjustments to operation to prevent overheating; overvoltage protection by providing safeguards against voltage spikes that could damage batteries 13 or related electronics; and undervoltage lockout by preventing operation when voltage levels are too low, protecting batteries 13 from deep discharge.

Additionally, the power management system may include a DC-DC converter 32, responsible for converting stored energy from energy storage system 12 into direct current with the desired voltage and current levels required by connected devices and systems. DC-DC converter 32 may ensure seamless integration with various onboard systems and devices, providing stable and efficient power delivery. The power management system may also utilize economical resettable fuses (such as 2920 surface-mount fuses) and GPIO-controlled MOSFETs for reliable circuit protection and switching capabilities. This design may replace the need for external eFuse modules, offering a purpose-built solution tailored specifically for this application. The MOSFETs may act as electronic switches controlled by the microcontroller's GPIO pins, allowing precise and efficient management of power distribution to connected devices and circuits.

To facilitate the allocation of power to specific systems and devices, the power management system may also include a power distribution module 34, which may perform a distribution function. Power distribution module 34 may act as a central hub that directs and allocates the available electrical energy to specific systems or devices based on their power requirements and user inputs. Power distribution module 34 may interface with the advanced control systems, allowing users to manage power distribution through physical user interface 18, voice recognition commands, mobile application via BLE, BLE remote, and/or wired remote control. Power distribution module 34 may incorporate GPIO-controlled MOSFETs and resettable fuses for each circuit, providing reliable circuit protection and switching capabilities. Power distribution module 34 may ensure that each connected device receives the appropriate voltage and current while safeguarding against overcurrent and short-circuit conditions. Power distribution module 34 may also enable the integration of additional energy storage or generation capacity through auxiliary power circuits, offering scalability and flexibility to the user.

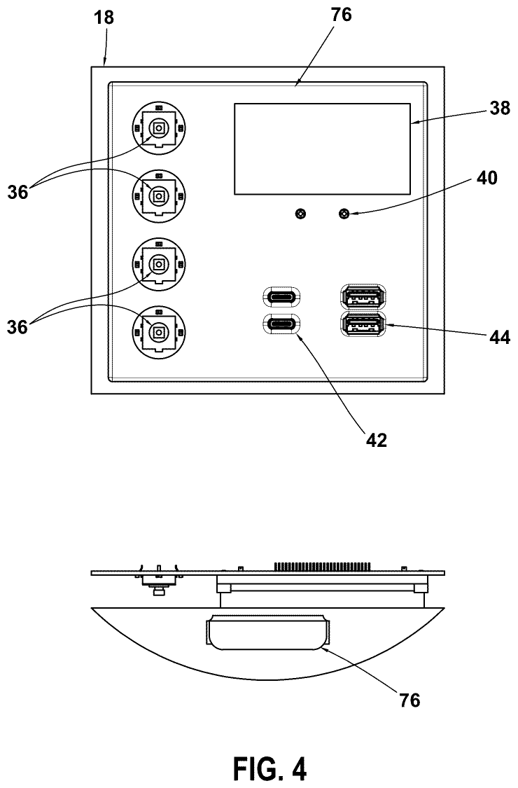

APU 10 may also feature physical user interface 18, as shown in FIG. 4. Physical user interface 18 may include a plurality of illuminated pushbutton switches 36. In one or more embodiments, each switch 36 may be associated with a different 12V DC circuit, such as the running circuit, cockpit circuit, masthead circuit, or auxiliary power circuit. When one of the plurality of switches 36 is pressed, it may energize or de-energize the corresponding circuit. Switches 36 may be designed to provide visual feedback, either illuminating only when activated or remaining continuously illuminated for increased visibility in low-light conditions. In addition to physical control, APU 10 allows users to control these circuits through advanced interfaces. Such advanced interfaces may include voice recognition commands which may allow users to issue spoken commands to control circuits; a mobile application via BLE which may offer remote control and monitoring of circuits through a user-friendly application; and/or BLE remote or wired remote control which may enable control from a distance using dedicated remote devices. This multimodal control may enhance user convenience and safety, allowing for hands-free operation and flexibility in various situations. In one or more embodiments, physical user interface 18 also includes a battery management display 38, which may provide real-time information on battery status, system performance, and telemetry data from the integrated sensor suite. Users can navigate and adjust settings using a plurality of pushbutton switches 40 or through the other control interfaces.

In one or more embodiments, physical user interface 18 may include a backlit display screen 38 located adjacent to switches 36. Screen 38 may display real-time information related to battery management system 16, power management system, and other system parameters, providing users with comprehensive insights into the operation of APU 10. This information may also be accessible remotely via Bluetooth® Low Energy (BLE) communication through a dedicated mobile application, allowing users to monitor and control the system from their smartphones or tablets. In one or more embodiments, screen 38 may show details such as information about batteries 13 which may include the overall battery charge level, individual cell voltages, current usage, estimated remaining runtime, state of charge (SoC), and state of health (SoH); power input data which may include voltage and current input from renewable energy sources like solar panels 22 and wind turbines, as well as direct DC or AC charging sources; environmental data which may include temperature readings, humidity levels, pressure measurements, and other relevant data from the integrated sensor suite; and/or system status information which may include status indicators for connected devices and circuits, alerts for abnormal conditions (e.g., overtemperature warnings, overvoltage/undervoltage conditions), and feedback on user commands issued through voice recognition or remote interfaces. Screen 38 may also provide graphical representations, such as charts or gauges, to visualize data trends over time, enhancing user understanding of system performance.

In one or more embodiments, screen 38 may be a touchscreen display, enabling direct interaction with the system by tapping or swiping to navigate menus, adjust settings, or control connected devices and circuits. Users can customize settings, initiate charging processes, or access detailed telemetry data directly from the screen. In other embodiments, screen 38 may be controlled through manipulation of plurality of pushbutton switches 40 located nearby, providing tactile feedback for users who prefer physical buttons or when touchscreen operation is not practical due to environmental conditions. Physical user interface 18, including backlit display screen 38 and switches 36 and 40, may be designed to be intuitive and user-friendly, facilitating easy access to system information and controls. The backlighting of screen 38 may ensure visibility in various lighting conditions, including direct sunlight and low-light or nighttime environments. Interface 18 may also be constructed to be durable and resistant to harsh marine conditions, such as water exposure, salt corrosion, and temperature variations, ensuring reliable operation in challenging environments.

In addition to physical user interface 18, APU 10 may support advanced control interfaces, allowing users to interact with the system through voice recognition commands which may allow users to issue spoken instructions to control functions, providing hands-free operation; a mobile application via BLE which may include a user-friendly application which may enable remote monitoring and control of the system, access to detailed telemetry data, configuration of settings, and receipt of notifications or alerts; and/or a BLE remote or wired remote control which may include dedicated remote devices which may offer additional flexibility for controlling the system from a distance, suitable for various operational scenarios. This multimodal approach may provide flexibility and convenience, enabling users to choose the most suitable method of interaction based on their preferences and situational needs. This multimodal approach may also enhance safety by allowing users to maintain focus on operating the watercraft while still accessing critical system information and controls. By integrating backlit display screen 38 with the advanced control interfaces and comprehensive system monitoring capabilities, APU 10 may offer users a seamless and enhanced experience and allow for real-time monitoring, control, and customization of the system's functions, contributing to the overall efficiency, safety, and enjoyment of personal watercraft operations. The combination of tactile, visual, and voice-activated interfaces ensures that APU 10 may be accessible and user-friendly, accommodating a wide range of user preferences and operational conditions.

In one or more embodiments, physical user interface 18 may include an indicator light that displays different colors, such as steady green, flashing yellow, or steady red, based on the concentration of dissolved oxygen detected in the surrounding water by a dissolved oxygen sensor. This real-time feedback indicates conditions that are favorable, neutral, or unfavorable for wildlife, including but not limited to gamefish, baitfish, and waterfowl. In one or more embodiments, the dissolved oxygen sensor may be hull-mounted and utilize a spectroscopy-based method to measure the concentration of dissolved oxygen accurately and reliably. The spectroscopy-based dissolved oxygen sensor may operate by emitting light at specific wavelengths into the water and measuring the absorption and fluorescence characteristics that result from the interaction between the light and the dissolved oxygen molecules. In one or more embodiments, such a sensor may include a light source, such as a modulated LED or laser diode, and a photodetector that captures the returned light signals. The differences in the intensity and phase shift of the returned light, caused by the presence of dissolved oxygen, may allow for the sensor to determine the concentration of oxygen in the water. Such a sensor may also employ the principles of optical fluorescence quenching or absorption spectroscopy. In fluorescence quenching, a fluorescent dye embedded in a thin film or membrane is excited by a light source. Dissolved oxygen molecules interact with the excited dye molecules, reducing (quenching) the fluorescence emitted. The degree of quenching may be directly proportional to the concentration of dissolved oxygen. In absorption spectroscopy, the sensor may measure the amount of light absorbed at particular wavelengths characteristic of oxygen molecules. Sensor electronics may process these optical signals, applying calibration algorithms to convert the measurements into accurate dissolved oxygen concentrations. The resultant measurement from the spectroscopy-based sensor may determine the color of the indicator light shown on physical user interface 18. A steady green light may indicate optimal dissolved oxygen levels conducive to healthy aquatic life. A flashing yellow light may warn of moderate levels that may be less favorable, while a steady red light may signal low dissolved oxygen levels that could be harmful to wildlife. This immediate visual feedback may enable users to make informed decisions, such as relocating their watercraft or taking conservation measures.

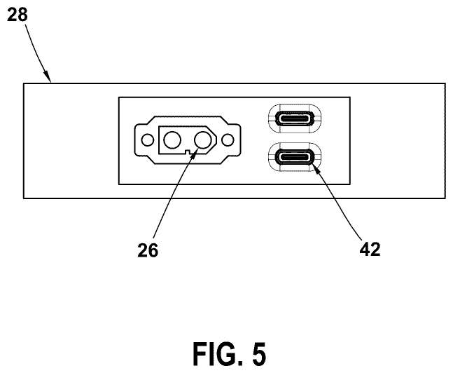

In one or more embodiments, physical user interface 18 may also include a plurality of USB-C ports 42 and a plurality of USB-A ports 44. Ports 42 and 44 may allow users to connect and charge various compatible devices, such as smartphones, tablets, or other USB-powered devices. As shown in FIG. 5, rear panel 26 may include main unit charging port 26 and two additional USB-C ports 42. In one or more embodiments, USB-C ports 42 can support the Power Delivery (PD) standard, enabling fast charging and higher power transfer, at a minimum.

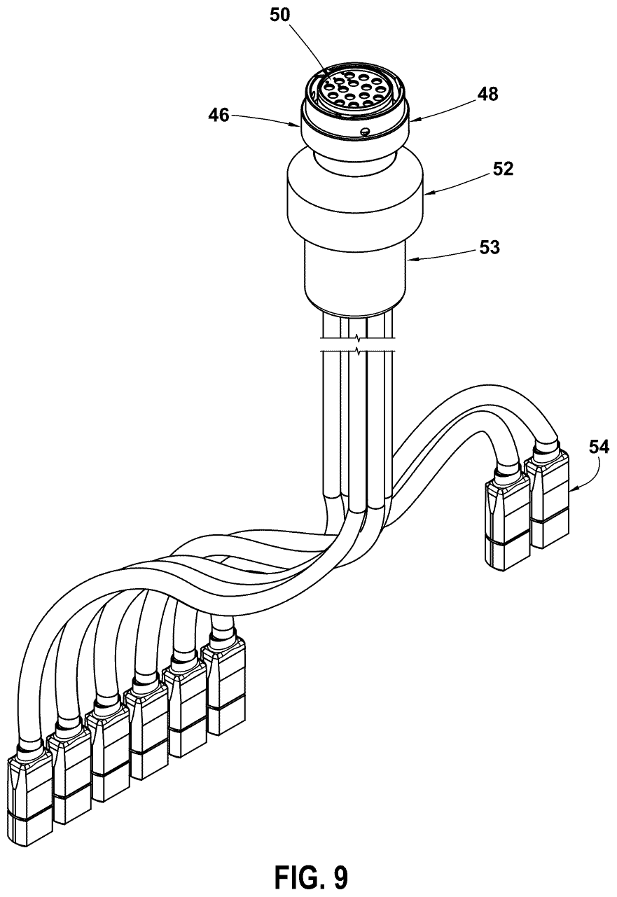

In one or more embodiments of the present disclosure, APU 10 may include a power delivery wiring harness system 46, as shown in FIG. 9. Wiring harness system 46 may simplify the installation and maintenance processes by providing a plug-and-play solution for installing APU 10 on a personal watercraft. Wiring harness system 46 may reduce the risk of wiring errors and facilitate faster assembly or repair of APU 10. Wiring harness system 46 may also offer protection from abrasion, moisture, heat, and other environmental factors, ensuring reliable and long-lasting electrical connections. Wiring harness system 46 may also connect to energy storage system 12 via an industrial connection system 48. In one or more embodiments, connection system 48 may include a quick connect/disconnect bayonet coupler 50 for easy removal and installation. Connection system 48 may be designed for harsh operating environments and critical applications where dirt, moisture, salt spray, and rough terrain can otherwise contaminate or damage the electrical connections.

In one or more embodiments, connection system 48 may further include a drip shield 52 for preventing water ingress through the mounting hole and a thermoplastic mating friction sleeve 53 which may provide a rigid support for connection system 48. Although not shown, APU 10 may also come with a sealed cap to be placed over coupler 50 when connection system 48 is disconnected from storage system 12. Connection system 48 may also include a structured assembly of electrical cables and wires 54 for transmitting electrical power and signals to various components, devices, and systems of APU 10. Cables and wires 54 may be carefully grouped, routed, and bundled together using color-coded protective sleeves, tapes, or conduit to create a neat and manageable assembly. Each cable and wire 54 may also be terminated with an electrical connector, a connector housing for easy manipulation, and a protective cap to protect contacts for the elements when not in use.

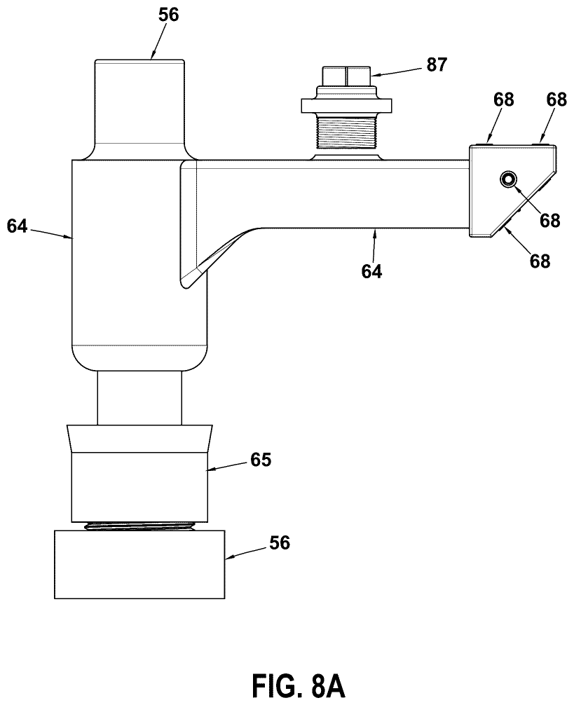

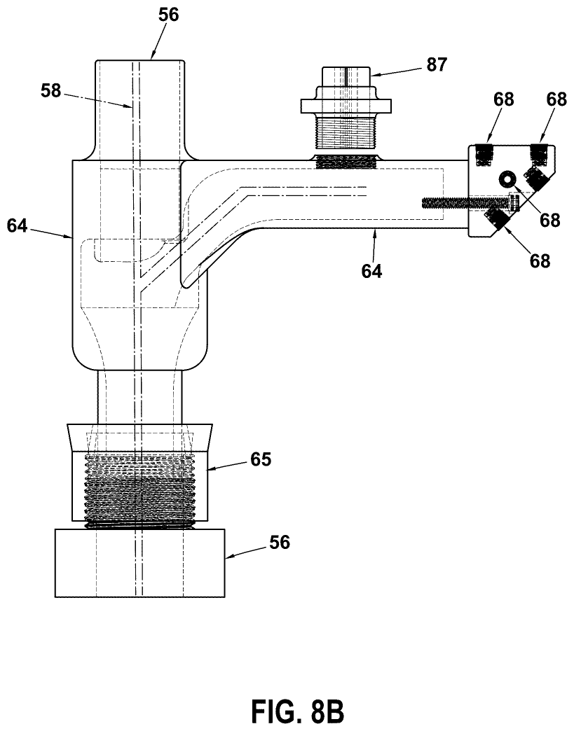

In one or more embodiments of the present disclosure, APU 10 includes a universal accessory mount 56, as shown in FIG. 8A and 8B. Mount 56 may provide a secure and watertight base with a through bulkhead channel 58 into which cables and wires 54 of connection system 48 can be inserted and upon which drip shield 52 and friction sleeve 53 may rest. Once friction sleeve 53 is inserted and drip shield 52 is fully seated, a main unit connector plug 60 of energy storage system 12 can be inserted into industrial connection system 48. Mount 56 may include a variable sized bracing support 62 that can be varied for various watercraft types, sizes, and bulkhead configurations. For non-bulkhead applications, mount 56 can be adapted for various watercraft types and sizes and may include adjustable brackets, clamps, or straps, to ensure a secure and stable installation with easy access to wiring harness connectors.

In one or more embodiments, mount 56 may be designed to serve as an attachment point for a wide range of accessories, components, devices, and systems. Mount 56 may be securely attached to APU 10 as discussed above. Once in place, mount 56 can be rotated 360-degrees by loosening compression fitting 65, rotating APU 10, and tightening compression fitting 65. Mount 56 may also include a variable length extension arm 64 that culminates in a mounting block 66 which serves as the primary attachment point for desired accessories, components, devices, and systems. In one or more embodiments, mounting block 66 may include at least two mounting points 68. In one or more embodiments, APU 10 may also include at least other mounting points variably positioned around APU 10. As shown in FIG. 8B, mount 56 can be securely attached to a watercraft with a specially designed watertight compression fitting 65.

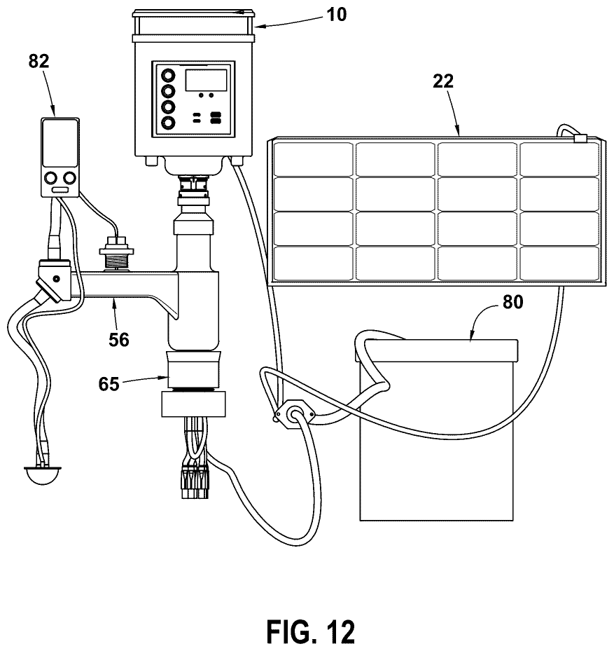

In one or more embodiments of the present disclosure, APU 10 may also be equipped with a waterproof cable gland 87, as depicted in FIGS. 8A and 8B. Gland 87 may offer a straightforward and user-friendly means for routing between 1 and 4 cables through bulkhead wire channel 58 of mount 56 into the interior bulkhead, ensuring secure and protected connections. As illustrated in FIG. 12, the power cable for a fish-finder and sonar unit 82 passes through waterproof cable gland 87. Gland 87 may be composed of an exterior threaded thermoplastic housing, enclosing a neoprene rubber insert with channels, accommodating up to 4 wires.

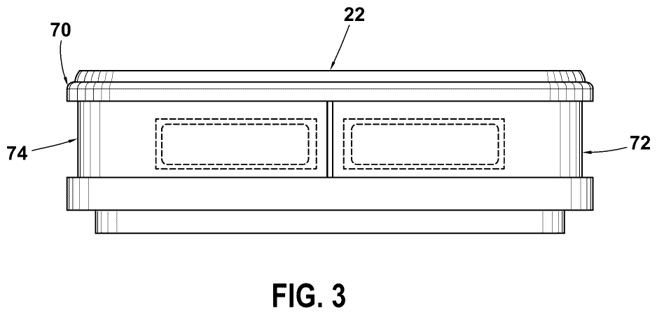

In one or more embodiments of the present disclosure, APU 10 may also include an advanced onboard lighting system 70, as shown in FIG. 3. As depicted in FIGS. 1 and 2, onboard lighting system 70 may incorporate one or more solar panels 22 mounted directly on its surface to provide supplementary power for the lighting components. Lighting system 70 may include a red light 72 on the left (port) side and a green light 74 on the right (starboard) side when facing forward, providing 112.5 degrees of visibility on both the port and starboard bow of the vessel, in compliance with maritime regulations. In one or more embodiments, these lights 72 and 74 are controllable via multiple interfaces, including physical pushbutton switches 36 on physical user interface 18, voice recognition commands via a voice recognition interface, a mobile application control interface, a BLE remote interface, and/or a wired remote-control interface. This multimodal control enhances user convenience and safety by allowing hands-free operation when necessary.

Additionally, a downward-facing blue cockpit light 76 may be positioned above backlit display screen 38, as shown in FIG. 4, to ensure visibility in low-light conditions without impairing the user's night vision. Cockpit light 76 can also be controlled through the various control interfaces mentioned above. In one or more embodiments, onboard lighting system 70 may also feature a stern light, which can be removed and temporarily attached to magnetic hull-mounted attachment points. These magnetic attachment points may provide both a secure mounting base and a power connection via electrical cabling linked to the wiring harness within the hull of the watercraft. This design allows for flexible positioning of the lights to accommodate different watercraft configurations and enhances visibility. Alternatively, in other embodiments, the detachable lights are equipped with standalone rechargeable power sources and communicate wirelessly with APU 10 via BLE. Each light may have a small solar panel embedded in its top surface to replenish the power source in situ. When not in use, the lights can be reattached to the onboard lighting system, where they are conditioned and recharged by the power management system for future use. Lighting system 70 may also support automatic illumination upon attachment to the magnetic mounts or can be controlled remotely through physical user interface 18, voice commands, a mobile application, BLE remote, and/or wired remote. This flexibility allows users to manage the lighting according to their preferences and situational needs. In one or more embodiments, all watercraft lighting provided by APU 10 may comply with Title 33, Chapter I, Subchapter E, Part 83, Subpart C of the Code of Federal Regulations, ensuring adherence to navigational rules and safety standards.

As stated above, DC electrical power can be supplied to APU 10 through main unit charging port 26, with power sourced from various inputs such as direct DC sources, solar panels (like solar panels 22), an AC to DC wall adapter, wind turbines powering permanent magnet DC generators, or wind turbines with AC to DC conversion systems. Once the power reaches main unit charging port 26, it may be directed to charge controller 24. Charge controller 24 may condition and manage electrical power to effectively charge energy storage system 12. Charge controller 24 may take into consideration the specific battery chemistry, cell count, and voltage/current requirements of rechargeable batteries 13 within energy storage system 12. Charge controller 24 may also enable APU 10 to start up instantly, even under low battery voltage conditions, making it well-suited for renewable energy applications such as solar and wind charging. In one or more embodiments, charge controller 24 may also incorporate an advanced high-resolution measurement system that provides detailed battery telemetry information. This information may include circuit voltages, current levels, battery resistance, temperature readings, and data from the integrated sensor suite, which may include humidity, temperature, and pressure sensors. Charge controller 24 may also utilize this data to optimize charging algorithms, enhance battery health, and improve overall system performance.

In one or more embodiments, charge controller 24 may allow for the configuration of various charging parameters such as voltage and current levels, termination algorithms, and system status alerts. Access to the telemetry information and configuration settings can be achieved through multiple user interfaces, including backlit display screen 38, voice recognition commands, a mobile application via Bluetooth® Low Energy (BLE) communication, a BLE remote, and/or a wired remote control. Backlit display screen 38, in conjunction with the plurality of pushbutton switches 40, may enable users to monitor overall system performance and make necessary adjustments for optimal charging and battery management. The integration of voice recognition and wireless communication interfaces may provide enhanced convenience, allowing users to interact with the system hands-free or remotely. Users can issue voice commands to retrieve telemetry data or adjust charging settings. The mobile application and BLE remote may offer intuitive graphical interfaces for monitoring and control, providing real-time updates and customizable alerts.

In one or more embodiments, charge controller 24 may be integrated with the power management system, which includes a power distribution system utilizing economical resettable fuses (such as 2920 surface-mount fuses) and GPIO-controlled MOSFETs for reliable circuit protection and switching capabilities. This design may replace the need for external eFuse modules, enhancing safety and reducing reliance on discrete units not purpose-designed for this application. By incorporating resettable fuses and MOSFETs, APU 10 may achieve efficient and precise control over power distribution to connected devices and circuits, all managed via the microcontroller's GPIO pins. Charge controller 24, in conjunction with the advanced power management system, may ensure efficient energy utilization, robust protection mechanisms, and flexible user control interfaces. This comprehensive approach may enhance the reliability, safety, and user experience with APU 10, making it adaptable to various power sources and user requirements.

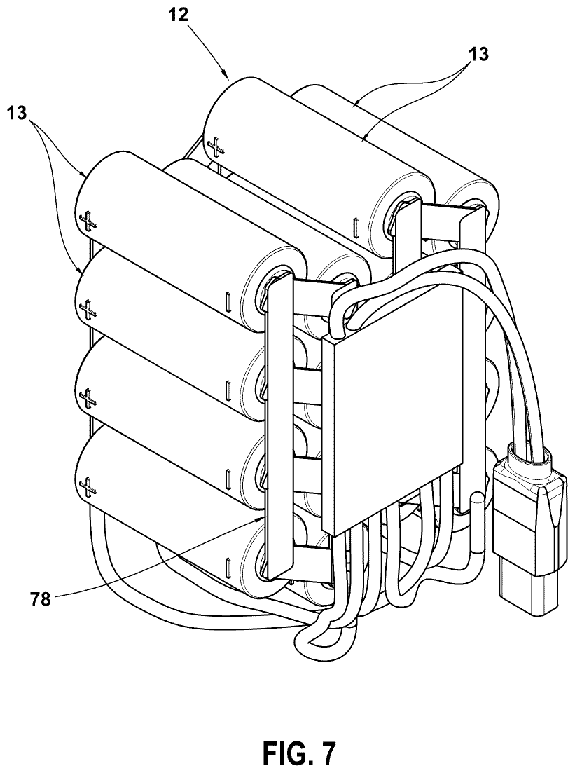

Energy storage system 12, as discussed above, may include rechargeable batteries 13, which may include lithium iron phosphate (LiFePO₄), lithium-ion, or sealed lead-acid chemistries. Batteries 13 may serve as the power source for any downstream devices and loads used in conjunction with APU 10. Batteries 13 may include one or more individual cells connected in series and/or parallel configurations using soldered or spot-welded nickel busbars 78, as shown in FIG. 7. This configuration may allow for customizable voltage and capacity levels to meet specific power requirements. Battery management system 16 may include essential functions for protecting, monitoring, and balancing batteries 13 to ensure the safe and efficient operation of energy storage system 12. Battery management system 16 may help maintain the health of the individual cells and extends the overall longevity of energy storage system 12.

Battery management system 16 may include a comprehensive set of safeguards and advanced features. Once such safeguard may include cell voltage protection which may guard against overvoltage and undervoltage conditions by monitoring each cell individually and preventing damage due to excessive charging or discharging. Another safeguard may include current protection which may protect against overcurrent during charging and discharging, as well as short-circuit conditions. This may be achieved through integrated sensing mechanisms and control of switching elements such as Field-Effect Transistors (FETs). Another safeguard may include temperature protection which may include the monitoring of cell temperatures using integrated temperature sensors to prevent overtemperature and undertemperature conditions during both charging and discharging cycles. Thermal management strategies may be implemented to maintain optimal operating temperatures. Another safeguard may include open cell and open wire detection which may identify faults such as disconnected cells or broken connections, ensuring the integrity of batteries 13 and preventing unsafe operating conditions. Another safeguard may include FET body diode protection which may include protecting the switching elements within battery management system 16 by preventing reverse current flow through the FET body diodes, enhancing reliability. Another safeguard may include a battery drain protection mode which may minimize parasitic power consumption when APU 10 is idle, extending the standby time and preserving battery life. Another safeguard may include ultra-low current hibernation and storage modes, which may reduce power consumption to minimal levels during periods of inactivity or storage, preventing deep discharge of batteries 13. Yet another safeguard may include the use of a smart and passive cell balancing algorithm which may utilize both passive and active balancing techniques to minimize voltage imbalances among the cells within energy storage system 12 while enhancing the overall lifespan and performance of batteries 13 by ensuring uniform charge and discharge cycles across all cells.

In addition to these safeguards, battery management system 16 may integrate with microcontroller unit (MCU) and communicate with advanced control interfaces, including physical user interface 18, a voice recognition interface, a mobile application interface via Bluetooth® Low Energy (BLE), a BLE remote-based interface, and/or a wired remote-control interface. Users can access detailed battery telemetry information such as individual cell voltages, total pack voltage, current levels, state of charge (SoC), state of health (SoH), battery resistance, and temperature readings. Battery management system 16 also processes data from the integrated sensor suite, including humidity, temperature, and pressure sensors, to optimize performance of batteries 13 and to adjust charging algorithms accordingly. For example, temperature data can influence charging rates to prevent overheating or improve efficiency in colder environments. Through the various control interfaces, users can monitor the health and status of energy storage system 12 in real-time. Users can receive alerts for any abnormal conditions, such as overtemperature warnings or voltage deviations, enabling proactive maintenance and enhancing safety. In one or more embodiments, adjustments to battery management settings can be made via voice commands, mobile applications, and/or physical user interface 18.

Integration of economical resettable fuses (such as 2920 surface-mount fuses) and GPIO-controlled MOSFETs within the power management system further enhances protection and control over energy storage system 12. This design may replace external eFuse modules and may provide reliable circuit protection and switching capabilities tailored specifically for this application. MOSFETs may act as electronic switches controlled by the MCU's GPIO pins, allowing for precise management of power distribution to connected devices and circuits. In one or more embodiments, battery management system 16, in conjunction with energy storage system 12, forms a robust and intelligent power source for APU 10. Battery management system 16 may therefore ensure safety, extend the lifespan of batteries 13, enhances performance, and provide users with comprehensive monitoring and control capabilities through advanced interfaces and sensor integrations.

As stated above, each switch 36 may be associated with a different 12V DC circuit. In one or more embodiments, these circuits include, but are not limited to, a running circuit, a cockpit circuit, a masthead circuit, and an auxiliary power circuit. APU 10 may allow users to control these circuits not only through physical pushbutton switches 36 on user interface 18 but also via voice recognition commands, a mobile application through Bluetooth® Low Energy (BLE) communication, a BLE remote, and/or a wired remote control. This multimodal control may provide enhanced convenience and safety, allowing for hands-free operation when necessary. Power distribution to these circuits may be managed by the power management system, which may utilize economical resettable fuses (such as 2920 surface-mount fuses) and GPIO-controlled MOSFETs. This design may replace the need for external eFuse modules and may therefore provide reliable circuit protection and switching capabilities tailored specifically for this application. MOSFETs may act as electronic switches controlled by the microcontroller's GPIO pins, enabling precise and efficient management of power to each circuit.

With the appropriate electrical connectors or adapters, most 12V DC powered devices or accessories can be connected and powered by APU 10. APU's 10 compatibility with a wide range of common marine accessories allows users to customize their watercraft according to their specific needs. Additionally, APU 10 may include one or more auxiliary power supply circuits, offering the user flexibility to expand their overall energy storage and generation capacity. These auxiliary circuits can be used to connect additional batteries or renewable energy sources, such as solar panels 22 or wind turbines, enhancing the system's scalability and endurance. The integration of advanced control interfaces also extends to the management of these auxiliary circuits. Users can monitor the status of connected devices, adjust power settings, and receive alerts through physical user interface 18, voice commands, mobile application, BLE remote, and/or wired remote. This comprehensive control may therefore ensure optimal performance and safety of all connected devices and accessories.

APU 10 may be designed to be highly versatile and compatible with a broad spectrum of devices and accessories that utilize 12V DC power or can interface through the universal sensor connection. This compatibility extends to both current equipment and potential future developments in marine and related technologies. Devices that can be utilized with APU 10 may include, but are not limited to renewable energy devices, navigation and detection equipment, lighting systems, mechanical and propulsion device, environmental monitoring devices, communication and entertainment devices, and/or fishing and recreational devices.

In one or more embodiments, renewable energy devices that can be utilized with APU 10 may include but are not limited to solar panels (in addition to solar panels 22) and photovoltaic cells which may be used to enhance energy harvesting capabilities, wind turbines which may harness wind energy to generate electrical power, wave energy generators which may convert wave motion into usable electrical energy, and other supplemental renewable energy systems.

In one or more embodiments, navigation and detection equipment that can be utilized with APU 10 may include but are not limited to sonar and fish finders which may utilize sound waves for underwater detection, aiding navigation and fishing, radar systems which may utilize radio waves to detect objects and determine distance, speed, and direction, LiDAR systems which may utilize laser light for precise distance measurements and mapping, depth-finding instruments which may measure water depth for safe navigation, and other detection and ranging devices which may be utilized for enhanced situational awareness.

In one or more embodiments, lighting systems that can be utilized with APU 10 may include but are not limited to running lights and navigation lights which may be utilized for compliance with maritime regulations, and which may provide improved visibility, cockpit and masthead lights which may providing illumination for operational areas, and specialized lighting sources which may include wildlife attraction lights or visibility enhancement lights.

In one or more embodiments, mechanical and propulsion devices that can be utilized with APU 10 may include but are not limited to light-duty bilge pumps which may be utilized for removing water from the vessel, live well aeration and circulation pumps which may be utilized for maintaining oxygen levels for live bait or catches, light-duty propulsion systems which may include electric trolling motors or other small-scale propulsion devices, and anchoring and retrieval devices.

In one or more embodiments, environmental monitoring sensors that can be utilized with APU 10 may include but are not limited to meteorological sensors which may measure temperature, humidity, barometric pressure, and wind speed, hydrological sensors and probes which may be utilized to monitor dissolved oxygen levels, salinity, turbidity, and other water quality parameters, and other environmental sensors.

In one or more embodiments, communication and entertainment devices that can be utilized with APU 10 may include but are not limited to marine radios and communication equipment which may be utilized for vessel-to-vessel or vessel-to-shore communication, GPS units and navigation aids which may be utilized to provide location data and navigational assistance, and Bluetooth® speakers and audio systems which may be utilized for entertainment purposes.

In one or more embodiments, fishing and recreational accessories that can be utilized with APU 10 may include but are not limited to action camera mounts which may be utilized for recording activities, tackle management systems which may be utilized for organizing fishing gear, and rod holders and mounts.

The universal sensor connection aspect of APU 10 may provide a pathway for seamless integration with a variety of sensors and devices, including those that may be developed in the future. The design of APU 10 may ensure that APU 10 remains adaptable and can accommodate new technologies as they emerge, without requiring significant modifications. By supporting both existing devices and plausible future developments that operate on 12V DC power or interface through the universal sensor connection, APU 10 may offer users the flexibility to customize their watercraft according to their specific needs and preferences. This forward-compatible approach allows for the incorporation of innovative technologies and ensures that the system remains relevant and functional as new advancements become available.

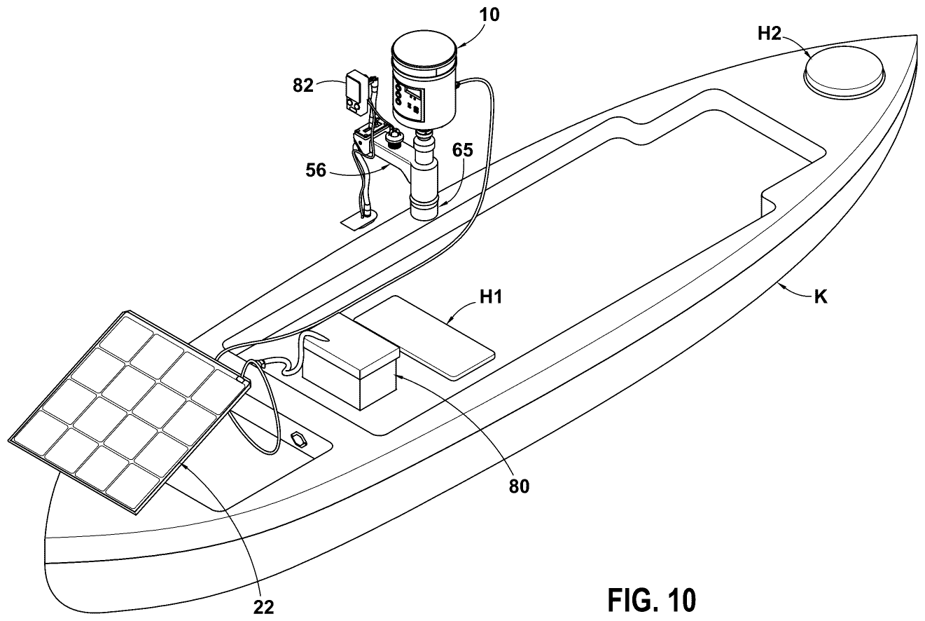

FIG. 10 shows APU 10 of the present disclosure secured to a kayak K. As discussed above, APU 10 may be secured to kayak K with watertight compression fitting 65. FIG. 10 also shows some secondary devices connected to APU 10, specifically a secondary battery source 80, a fish-finder and sonar unit 82, and a singular 50-watt solar panel 22. Fish-finder and sonar unit 82 may be secured directly to accessory mount 56 while secondary battery source 80 is just shown sitting in the deck of the kayak K. In the embodiment shown in FIG. 10, the structured assembly of electrical cables and wires 54 shown in FIG. 1 can be accessed through either of the hatches H1 or H2 of kayak K.

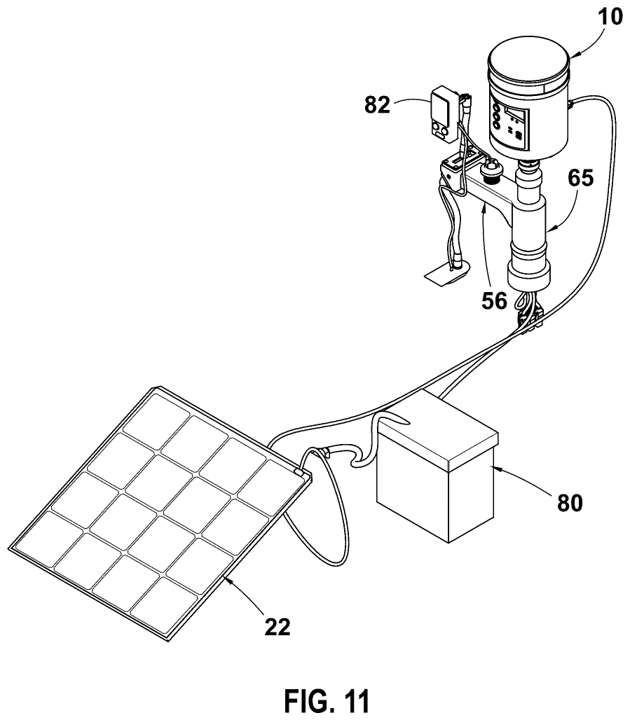

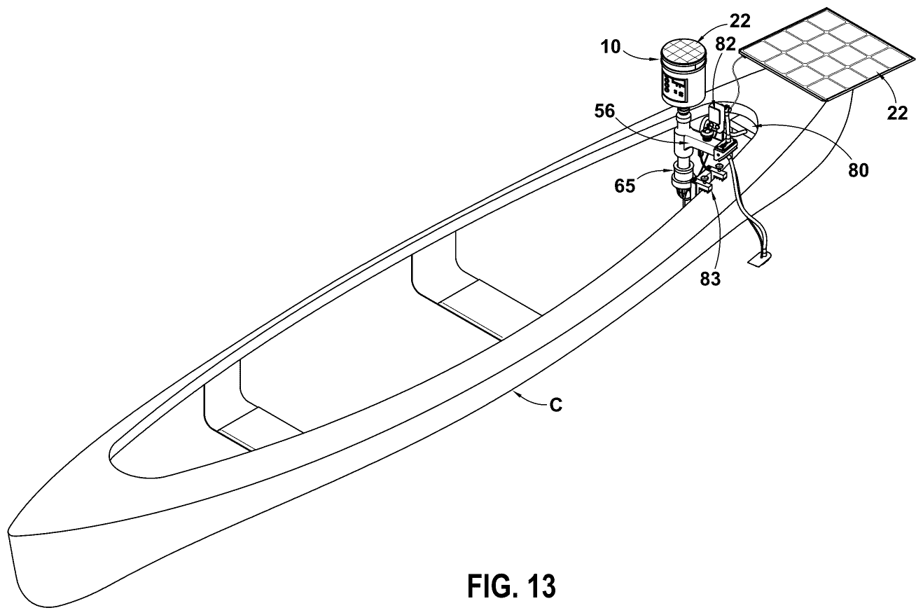

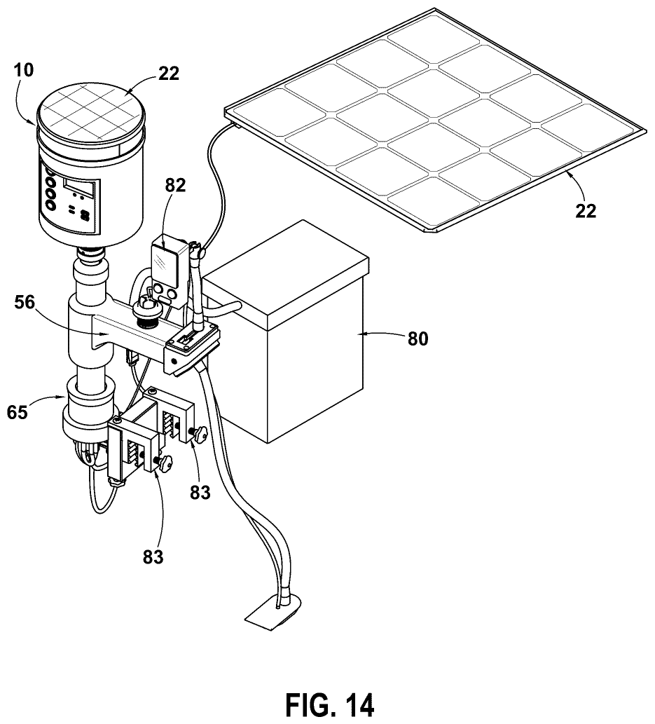

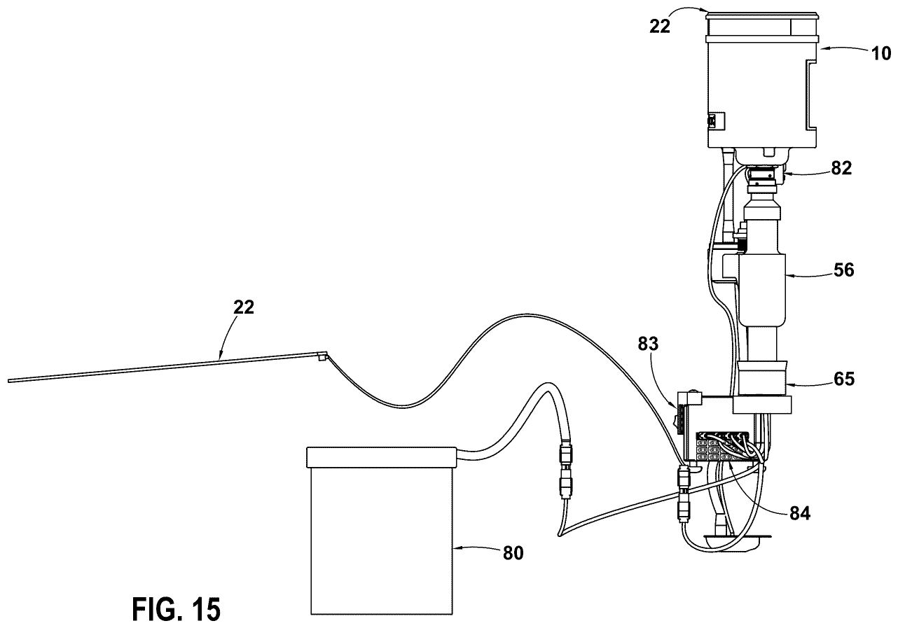

FIG. 13 shows APU 10 of the present disclosure secured to a canoe C. As discussed above, APU 10 may be secured to canoe C using clamp mount configuration 83. This configuration utilizes compression fitting 65 to secure APU 10 to clamp mount configuration 83 and allows for APU 10 to be rotated 360 degrees per user preference. FIG. 11 shows a close-up view of the auxiliary power unit and accessories from FIG. 10 connected in a bulkhead mount configuration. FIG. 12 provides a side view of the auxiliary power unit and accessories in bulkhead mount configuration from FIG. 11. FIG. 13 also shows some secondary devices connected to unit 10, specifically secondary battery source 80, fish-finder and sonar unit 82, and a singular 50-watt solar panel 22. Fish-finder and sonar unit 82 may be secured directly to accessory mount 56 while secondary battery source 80 is shown sitting on the deck of canoe C. FIG. 14 shows the auxiliary power unit connected to the accessories from FIG. 13. In the embodiment shown in FIG. 15, the structured assembly of electrical cables and wires 54 shown in FIG. 1 are attached to the clamp mount configuration 83 via connection of unused connectors to connector storage panel 84.

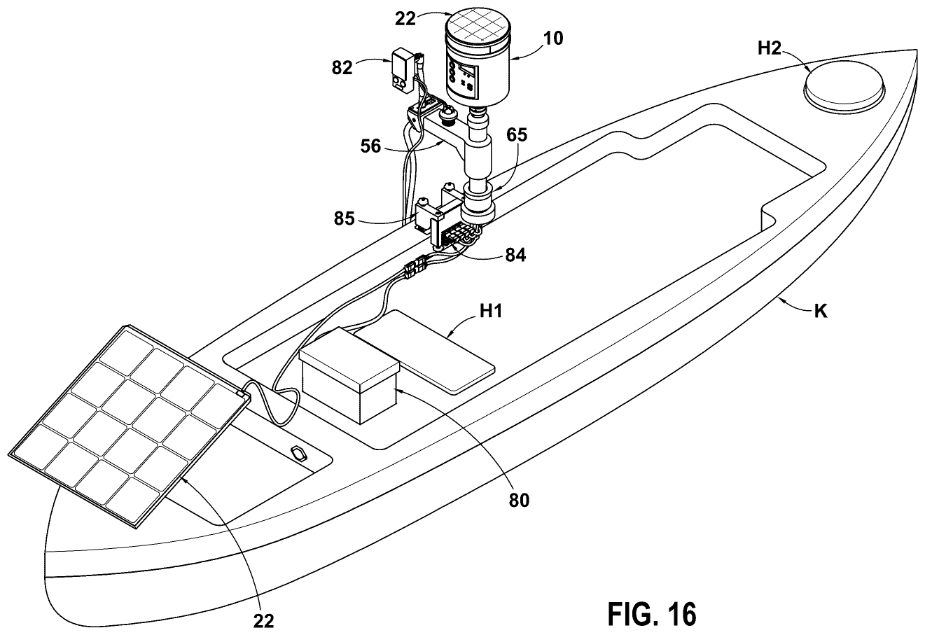

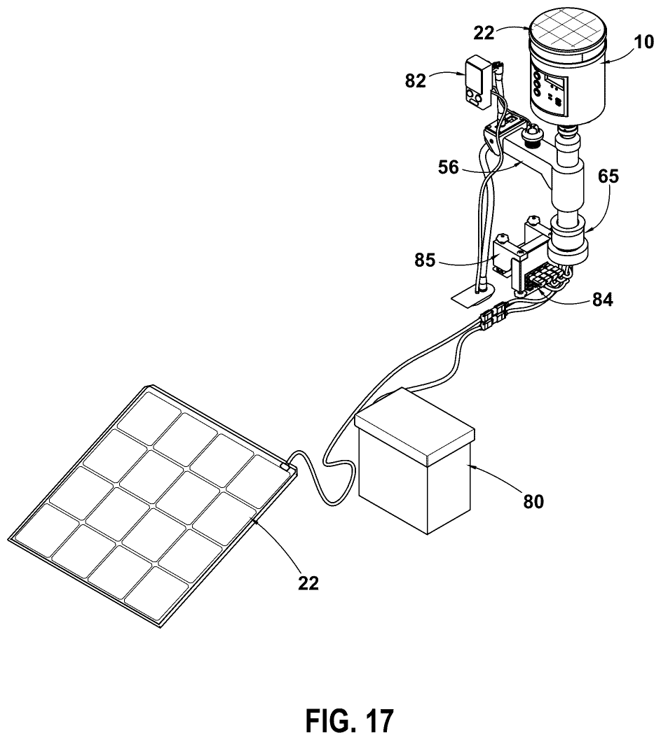

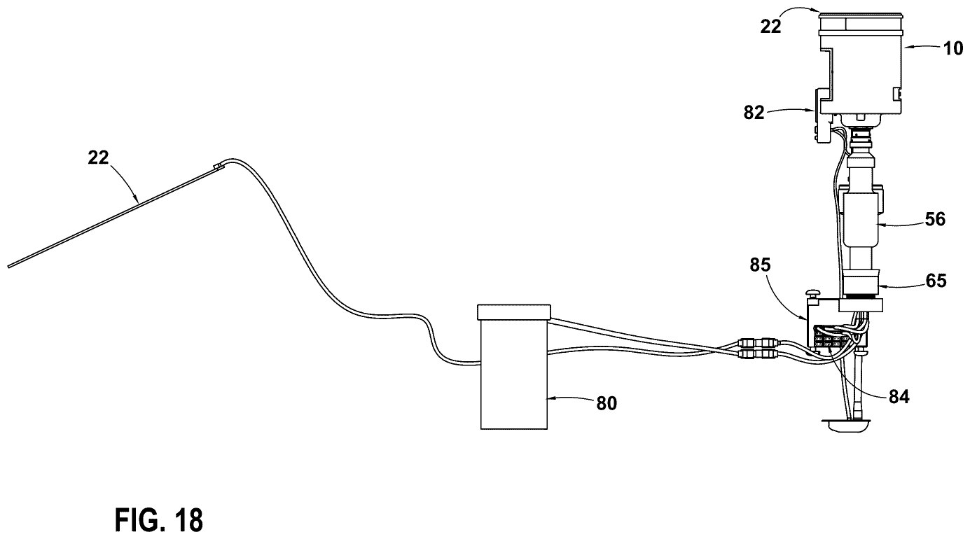

FIG. 16 shows APU 10 of the present disclosure secured to kayak K. As discussed above, APU 10 is secured to kayak K using track mount configuration 85. This configuration utilizes compression fitting 65 to secure APU 10 to track mount configuration 85 and allows APU 10 to be rotated 360 degrees per user preference. FIG. 17 also shows some secondary devices connected to APU 10, specifically secondary battery source 80, fish-finder and sonar unit 82, and a singular 50-watt solar panel 22. Fish-finder and sonar unit 82 may be secured directly to accessory mount 56 while secondary battery source 80 is shown sitting on the deck of kayak K. In the embodiment shown in FIG. 18, the structured assembly of electrical cables and wires 54 shown in FIG. 1 are attached to the clamp mount configuration 83 via connection of unused connectors to the connector storage panel 84.

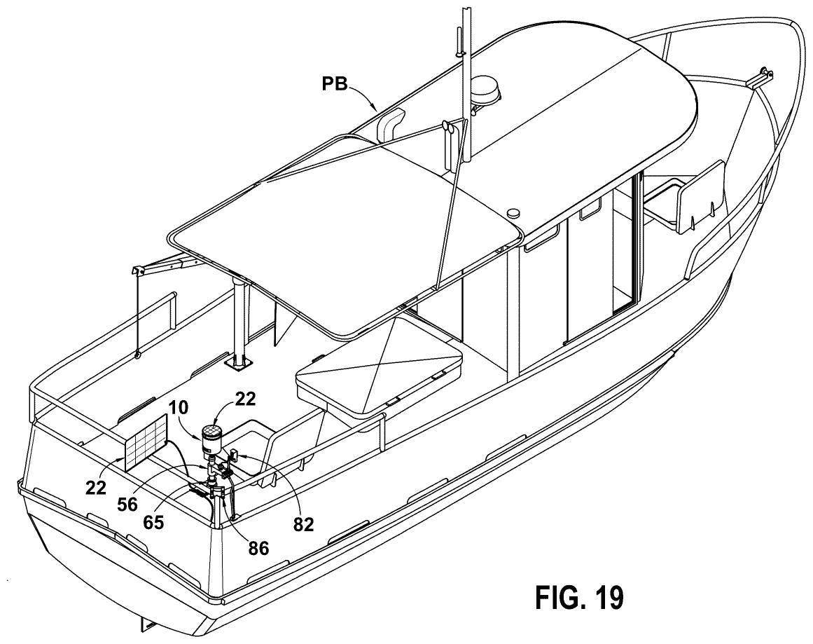

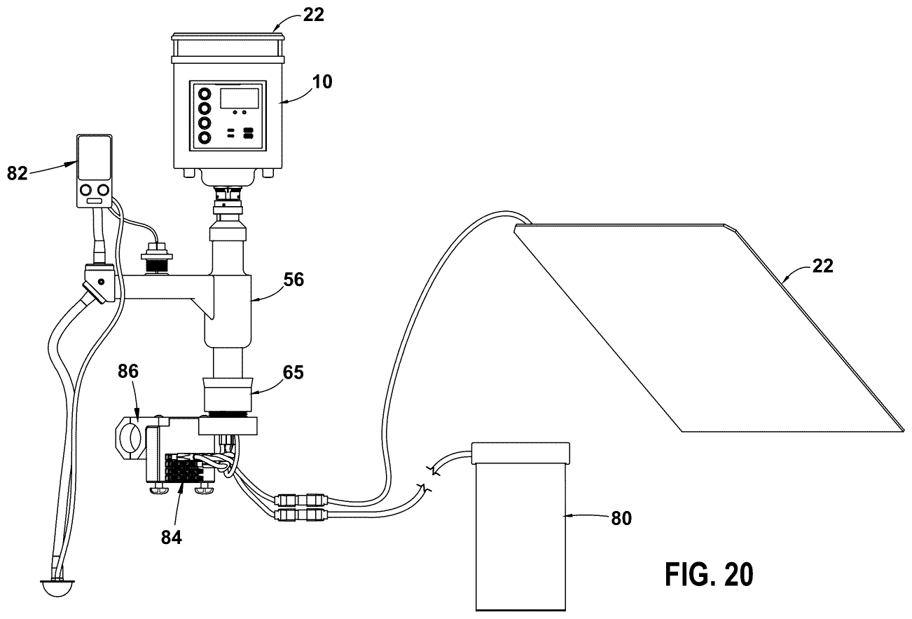

FIG. 19 shows APU 10 of the present disclosure secured to a power boat PB. As discussed above, APU 10 is secured to power boat PB using tube mount configuration 86. This configuration utilizes compression fitting 65 to secure APU 10 to tube mount configuration 86 and allows APU 10 to be rotated 360 degrees per user preference. FIG. 20 also shows some secondary devices connected to APU 10, specifically secondary battery source 80, fish-finder and sonar unit 82, and a singular 50-watt solar panel 22. Fish-finder and sonar unit 82 may be secured directly to accessory mount 56 while secondary battery source 80 is shown sitting on the deck of power boat PB. The structured assembly of electrical cables and wires 54 shown in FIG. 1 are attached to the tube mount configuration 86 via connection of unused connectors to connector storage panel 84.

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An auxiliary power system comprising: an energy storage system comprising: one or more rechargeable batteries, and a battery management system; a power management system comprising: a charge controller, one or more energy sources, a DC-DC converter, and a power distribution system; a user interface comprising: one or more DC circuits, one or more switches associated with the one or more DC circuits, a battery management display, an interface mechanism, and one or more power delivery ports; a wiring harness; a watertight mounting system, and a universal accessory mount comprising one or more mounting points wherein the universal accessory mount is configured to attach to the watertight mounting system.

### Example 2

The system of Example 1, wherein the interface mechanism includes one or more of a physical user interface, a voice recognition interface, a mobile application interface, a Bluetooth® Low Energy (BLE) communication interface, a Bluetooth® Low Energy (BLE) remote interface, and/or a wired remote interface.

### Example 3

The system of Example 1, further comprising a comprehensive sensor suite comprising one or more sensors configured to collect operational and environmental data; and wherein the one or more sensors include one or more of an inertial measurement unit (IMU), a proximity sensor, a color and light sensor, a humidity sensor, a temperature sensors, a pressure sensor, and/or a dissolved oxygen sensor.

### Example 4

The system of Example 1, wherein the battery management system comprises one or more integrated circuits configured to perform one or more of the following functions: monitor the overall condition, remaining lifespan, and performance characteristics of the one or more rechargeable batteries; protect the energy storage system from overvoltage, undervoltage, and overcurrent conditions; manage cell balancing of the one or more rechargeable batteries; regulate temperature of the one or more rechargeable batteries; and detect faults or abnormalities in the battery management system.

### Example 5

The system of Example 1, wherein the charge controller is configured to: optimize charging parameters, monitor temperature of the one or more rechargeable batteries, protect against short circuits within the one or more rechargeable batteries, protect against overvoltage and undervoltage of the one or more rechargeable batteries, and provide power from the one or more energy sources to the energy storage system.

### Example 6

The system of Example 1, wherein the power management system further comprises resettable fuses and GPIO-controlled MOSFETs and wherein the power management system is configured to direct available energy to one or more connected devices and systems.

### Example 7

The system of Example 1, wherein the one or more energy sources are selected from a group consisting of solar panels, wind turbines, wave energy generators, or photovoltaics.

### Example 8

The system of Example 1, wherein the wiring harness further comprises: a circular connection system, a thermoplastic mating friction sleeve, and an assembly of electrical wires.

### Example 9

The system of Example 1, further comprising an onboard lighting system comprising: one or more running lights, and one or more cockpit lights.

### Example 10

The system of Example 1, wherein the interface mechanism is configured to allow the user to monitor and control the charge controller.

### Example 11

The system of Example 1, wherein the charge controller is configured to optimize charging parameters using maximum power point tracking and adaptive charging profiles.

### Example 12

An auxiliary power system comprising: an energy storage system comprising: one or more rechargeable batteries, and a battery management system; a power management system comprising: a charge controller, one or more solar panels, a DC-DC converter, and a power distribution system; a wiring harness; a watertight mounting system; and a universal accessory mount comprising one or more mounting points wherein the universal accessory mount is configured to attach to the watertight mounting system.

### Example 13

The system of Example 12, further comprising a user interface comprising: one or more DC circuits, one or more switches associated with the one or more DC circuits, a battery management display, an interface mechanism, and one or more power delivery ports.

### Example 14

The system of Example 13, wherein the interface mechanism includes one or more of a physical user interface, a voice recognition interface, a mobile application interface, a Bluetooth® Low Energy (BLE) communication interface, a Bluetooth® Low Energy (BLE) remote interface, and/or a wired remote interface.

### Example 15

The system of Example 12, further comprising a comprehensive sensor suite comprising one or more sensors configured to collect operational and environmental data; and wherein the one or more sensors include one or more of an inertial measurement unit (IMU), a proximity sensor, a color and light sensor, a humidity sensor, a temperature sensors, a pressure sensor, and/or a dissolved oxygen sensor.

### Example 16

The system of Example 12, wherein the battery management system comprises one or more integrated circuits configured to perform one or more of the following functions: monitor the overall condition, remaining lifespan, and performance characteristics of the one or more rechargeable batteries; protect the energy storage system from overvoltage, undervoltage, and overcurrent conditions; manage cell balancing of the one or more rechargeable batteries; regulate temperature of the one or more rechargeable batteries; and detect faults or abnormalities in the battery management system.

### Example 17

The system of Example 12, wherein the charge controller is configured to: optimize charging parameters, monitor temperature of the one or more rechargeable batteries, protect against short circuits within the one or more rechargeable batteries, protect against overvoltage and undervoltage of the one or more rechargeable batteries, and provide power from the one or more energy sources to the energy storage system.

### Example 18

The system of Example 12, wherein the power management system further comprises resettable fuses and GPIO-controlled MOSFETs and wherein the power management system is configured to direct available energy to one or more connected devices and systems.

### Example 19

The system of Example 12, further comprising one or more energy sources selected from a group consisting of wind turbines, wave energy generators, or photovoltaics.

### Example 20

The system of Example 12, wherein the wiring harness further comprises: a circular connection system, a thermoplastic mating friction sleeve, and an assembly of electrical wires.

### Example 21

The system of Example 12, further comprising an onboard lighting system comprising: one or more running lights; and one or more cockpit lights.

### Example 22

The system of Example 18 wherein the power management system is further configured to direct available energy to one or more connected devices and systems based on the power requirements of the one or more connected devices and systems and user input.

### Example 23

The system of Example 12, wherein the interface mechanism is configured to allow the user to monitor and control the charge controller.

### Example 24

The system of Example 12, wherein the charge controller is configured to optimize charging parameters using maximum power point tracking and adaptive charging profiles.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those skilled in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions or other disclosure material set forth herein will only be incorporated to the extent that no conflict arises between that incorporated material and the existing disclosure material.

Versions described above may be designed to be disposed of after a single use, or they can be designed to be used multiple times. Versions may, in either or both cases, be reconditioned for reuse after at least one use. Reconditioning may include any combination of the steps of disassembly of the device, followed by cleaning or replacement of particular pieces, and subsequent reassembly. In particular, some versions of the device may be disassembled, and any number of the particular pieces or parts of the device may be selectively replaced or removed in any combination. Upon cleaning and/or replacement of particular parts, some versions of the device may be reassembled for subsequent use either at a reconditioning facility, or by an operator immediately prior to a procedure. Those skilled in the art will appreciate that reconditioning of a device may utilize a variety of techniques for disassembly, cleaning/replacement, and reassembly. Use of such techniques, and the resulting reconditioned device, are all within the scope of the present application.

Having shown and described various embodiments of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. An auxiliary power system comprising:
a. an energy storage system comprising:
i. one or more rechargeable batteries, and
ii. a battery management system,
b. a power management system comprising:
i. a charge controller,
ii. one or more energy sources,
iii. a DC-DC converter, and
iv. a power distribution system,
c. a user interface comprising:
i. one or more DC circuits,
ii. one or more switches associated with the one or more DC circuits,
iii. a battery management display,
iv. an interface mechanism, and
v. one or more power delivery ports,
d. a wiring harness,
e. a watertight mounting system, and
f. a universal accessory mount comprising one or more mounting points wherein the universal accessory mount is configured to attach to the watertight mounting system.

2. The system of claim 1, wherein the interface mechanism includes one or more of a physical user interface, a voice recognition interface, a mobile application interface, a Bluetooth® Low Energy (BLE) communication interface, a Bluetooth® Low Energy (BLE) remote interface, and/or a wired remote interface.

3. The system of claim 1, further comprising a comprehensive sensor suite comprising one or more sensors configured to collect operational and environmental data; and wherein the one or more sensors include one or more of an inertial measurement unit (IMU), a proximity sensor, a color and light sensor, a humidity sensor, a temperature sensors, a pressure sensor, and/or a dissolved oxygen sensor.

4. The system of claim 1, wherein the battery management system comprises one or more integrated circuits configured to perform one or more of the following functions:
a. monitor the overall condition, remaining lifespan, and performance characteristics of the one or more rechargeable batteries;
b. protect the energy storage system from overvoltage, undervoltage, and overcurrent conditions;
c. manage cell balancing of the one or more rechargeable batteries;
d. regulate temperature of the one or more rechargeable batteries; and
e. detect faults or abnormalities in the battery management system.

5. The system of claim 1, wherein the charge controller is configured to:
a. optimize charging parameters,
b. monitor temperature of the one or more rechargeable batteries,
c. protect against short circuits within the one or more rechargeable batteries,
d. protect against overvoltage and undervoltage of the one or more rechargeable batteries, and
e. provide power from the one or more energy sources to the energy storage system.

6. The system of claim 1, wherein the power management system further comprises resettable fuses and GPIO-controlled MOSFETs and wherein the power management system is configured to direct available energy to one or more connected devices and systems.

7. The system of claim 1, wherein the one or more energy sources are selected from a group consisting of solar panels, wind turbines, wave energy generators, or photovoltaics.

8. The system of claim 1, wherein the wiring harness further comprises:
a. a circular connection system,
b. a thermoplastic mating friction sleeve, and
c. an assembly of electrical wires.

9. The system of claim 1, further comprising an onboard lighting system comprising:
a. one or more running lights, and
b. one or more cockpit lights.

10. An auxiliary power system comprising:
a. an energy storage system comprising:
i. one or more rechargeable batteries, and
ii. a battery management system,
b. a power management system comprising:
i. a charge controller,
ii. one or more solar panels,
iii. a DC-DC converter, and
iv. a power distribution system,
c. a wiring harness,
d. a watertight mounting system, and
e. a universal accessory mount comprising one or more mounting points wherein the universal accessory mount is configured to attach to the watertight mounting system.

11. The system of claim 10, further comprising a user interface comprising:
a. one or more DC circuits,
b. one or more switches associated with the one or more DC circuits,
c. a battery management display,
d. an interface mechanism, and
e. one or more power delivery ports.

12. The system of claim 11, wherein the interface mechanism includes one or more of a physical user interface, a voice recognition interface, a mobile application interface, a Bluetooth® Low Energy (BLE) communication interface, a Bluetooth® Low Energy (BLE) remote interface, and/or a wired remote interface.

13. The system of claim 10, further comprising a comprehensive sensor suite comprising one or more sensors configured to collect operational and environmental data; and wherein the one or more sensors include one or more of an inertial measurement unit (IMU), a proximity sensor, a color and light sensor, a humidity sensor, a temperature sensors, a pressure sensor, and/or a dissolved oxygen sensor.

14. The system of claim 10, wherein the battery management system comprises one or more integrated circuits configured to perform one or more of the following functions:
a. monitor the overall condition, remaining lifespan, and performance characteristics of the one or more rechargeable batteries;
b. protect the energy storage system from overvoltage, undervoltage, and overcurrent conditions;
c. manage cell balancing of the one or more rechargeable batteries;
d. regulate temperature of the one or more rechargeable batteries; and
e. detect faults or abnormalities in the battery management system.

15. The system of claim 10, wherein the charge controller is configured to:
a. optimize charging parameters,
b. monitor temperature of the one or more rechargeable batteries,
c. protect against short circuits within the one or more rechargeable batteries,
d. protect against overvoltage and undervoltage of the one or more rechargeable batteries, and
e. provide power from the one or more energy sources to the energy storage system.

16. The system of claim 10, wherein the power management system further comprises resettable fuses and GPIO-controlled MOSFETs and wherein the power management system is configured to direct available energy to one or more connected devices and systems.

17. The system of claim 10, further comprising one or more energy sources selected from a group consisting of wind turbines, wave energy generators, or photovoltaics.

18. The system of claim 10, wherein the wiring harness further comprises:
a. a circular connection system,
b. a thermoplastic mating friction sleeve, and
c. an assembly of electrical wires.

19. The system of claim 10, further comprising an onboard lighting system comprising:
a. one or more running lights; and
b. one or more cockpit lights.

20. The system of claim 16 wherein the power management system is further configured to direct available energy to one or more connected devices and systems based on the power requirements of the one or more connected devices and systems and user input.
